(19) United States
(12) Patent Application Publication
(10) Pub. No.: US 2026/0303475 A1
(43) Pub. Date: Oct. 1, 2026

(54) MACHINE LEARNING (ML)-BASED METHOD FOR DETERMINING A CONTROL CHANNEL ELEMENT (CCE) AGGREGATION LEVEL FOR A USER EQUIPMENT (UE) IN A PHYSICAL DOWNLINK CONTROL CHANNEL (PDCCH)

(71) Applicants: Dawei NI, Lasalle (CA); Aaron CALLARD, Kanata (CA); Yimin NIE, Montreal (CA); Aydin SARRAF, Pierrefonds (CA)

(72) Inventors: Dawei NI, Lasalle (CA); Aaron CALLARD, Kanata (CA); Yimin NIE, Montreal (CA); Aydin SARRAF, Pierrefonds (CA)

(73) Assignee: TELEFONAKTIEBOLAGET LM ERICSSON (PUBL), Stockholm (SE)

(21) Appl. No.: 19/475,952

(22) PCT Filed: Apr. 18, 2023
(86) PCT No.: PCT/IB2023/053965

§ 371 Date: Oct. 16, 2025

(51) Int. Cl. H04L 41/16; H04B 17/309; H04W 76/28

(52) U.S. Cl. CPC H04L 41/16; H04B 17/346; H04W 76/28

(57) ABSTRACT

The disclosure relates to a ML-based method for determining a CCE aggregation level for a UE in a PDCCH. The method comprises obtaining RBS traces. The method comprises training, using first data obtained from the traces, a machine learning model to predict a probability of discontinuous transmission (DTX) “isDTX probability”. The method comprises inputting second data obtained from the traces into the machine learning model, obtaining the isDTX probability and expanding the second data with the isDTX probability. The method comprises, for each of a plurality of probability thresholds (PTs) and for each of a plurality of strategies, selecting a data having an isDTX probability greater or equal to the PT and best satisfying the strategy and using the data to train a classifier. The method comprises selecting one classifier and using the classifier for determining the CCE aggregation level for the UE in the PDCCH.

### TECHNICAL FIELD

The present disclosure relates to a machine learning (ML)-based control method to determine the control channel element (CCE) aggregation level for a user equipment (UE) in a physical downlink control channel (PDCCH).

### BACKGROUND

In long term evolution (LTE) and fifth generation (5G) cellular networks, the physical downlink control channel (PDCCH) carries scheduling assignments and other control information. A physical control channel is transmitted on an aggregation of one or several consecutive control channel elements (CCEs), where a control channel element corresponds to nine resource element groups, as shown in Table 1.

TABLE 1
Supported PDCCH formats

| PDCCH | Number of | Number of resource- | Number of |
|---|---|---|---|
| format | CCEs | element groups | PDCCH bits |
| 0 | 1 | 9 | 72 |
| 1 | 2 | 18 | 144 |
| 2 | 4 | 36 | 288 |
| 3 | 8 | 72 | 576 |

The power spectrum density (PSD) of a time series signal describes the distribution of power into frequency components composing that signal. In a PDCCH channel in LTE and 5G, the power spectrum density specifies the power distribution in resource elements transmitting toward the user equipment (UEs) 10, as illustrated in FIG. 1.

Channel state information (CSI) of the UE is transmitted to the radio base station (RBS) 20.

In most slots, the UE will attempt to decode the PDCCH by blindly attempting many different sizes (number of CCE) and different frequency locations. To be successfully decoded, the RBS must select one of these combinations that the UE will blindly decode. This selection is typically based on channel conditions as well as other users active in the system. Transparent to the UE, the RBS may also select the amount of transmit power to use for this transmission.

To solve this problem, prior solutions derive fixed mappings between previous channel quality indicator (CQI) feedback together with previous PDCCH performance for this UE (any failed PDCCH attempts) and the CCE and power level chosen.

An example of such a mapping is shown in table 2.

TABLE 2
A fixed/static CQI to CCE mapping

| CQI | CCE |
|---|---|
| 0-6 | 8 |
| 7-9 | 4 |
| 10-12 | 2 |
| 13-15 | 1 |

The RBS considers the most recent CQI feedback and uses the above lookup table to map the CQI to the chosen CCE.

As there are only a finite number of PDCCH resources, it is important that the mapping is neither too conservative, which causes only a limited number of users to be scheduled and lead to inferior performance, or too aggressive, which causes the PDCCH to not be decoded correctly and lead to poor performance.

Typically, the RBS attempts to select the CCE/power to achieve at most a 1% error rate on the PDCCH. This strikes a reasonable balance between overhead and error rate. This number 1% has been accepted as the default choice and it is sometimes enshrined in contracts and key performance indicators (KPIs).

Some form of configurability is generally granted to operators/designers to adjust the mapping. For example, the CQI parameter above may have a configurable offset value according to:

$$CQI\_eff = CQI + PDCCH\_offset .$$

### SUMMARY

There is provided a machine learning (ML)-based method for determining a control channel element (CCE) aggregation level for a user equipment (UE) in a physical downlink control channel (PDCCH). The method comprises obtaining radio base station (RBS) traces. The method comprises training, using first data obtained from the traces, a machine learning model to predict a probability of discontinuous transmission (DTX) “isDTX probability”. The method comprises inputting second data obtained from the traces into the machine learning model, obtaining the isDTX probability and expanding the second data with the isDTX probability. The method comprises, for each probability threshold (PT) of a plurality of PTs and for each strategy of a plurality of strategies, selecting a subset of the second data having an isDTX probability greater or equal to the PT, selecting a data from the subset of data, best satisfying the strategy and using the data to train a classifier. The method comprises selecting one classifier. The method comprises using the classifier for determining the CCE aggregation level for the UE in the PDCCH.

There is provided a system for determining a control channel element (CCE) aggregation level for a user equipment (UE) in a physical downlink control channel (PDCCH). The system comprises processing circuitry and a memory, the memory containing instructions executable by the processing circuitry. The system is operative to obtain radio base station (RBS) traces. The system is operative to train, using first data obtained from the traces, a machine learning model to predict a probability of discontinuous transmission (DTX) “isDTX probability”. The system is operative to input second data obtained from the traces into the machine learning model, obtain the isDTX probability and expand the second data with the isDTX probability. The system is operative to, for each probability threshold (PT) of a plurality of PTs and for each strategy of a plurality of strategies, select a subset of the second data having an isDTX probability greater or equal to the PT, select a data from the subset of data, best satisfying the strategy and use the data to train a classifier. The system is operative to select one classifier. The system is operative to use the classifier for determining the CCE aggregation level for the UE in the PDCCH.

There is provided a radio base station (RBS) operative to determine a control channel element (CCE) aggregation level for a user equipment (UE) in a physical downlink control channel (PDCCH). The radio base station comprises a processing circuitry and is configured to provide traces, for training a machine learning model to predict a probability of discontinuous transmission (DTX) “isDTX probability”. The machine learning model is trained using first data obtained from the traces. The second data, obtained from the traces, is expanded with the isDTX probability obtained from inputting the traces into the machine learning model. For each probability threshold (PT) of a plurality of PTs and for each strategy of a plurality of strategies: a subset of the second data having an isDTX probability greater or equal to the PT is selected, a data from the subset of data, best satisfying the strategy is selected and the data is used to train a classifier. This produces a plurality of classifiers. The radio base station is configured to obtain the plurality of classifiers. The radio base station is configured to select one classifier. The radio base station is configured to use the classifier for determining the CCE aggregation level for the UE in the PDCCH.

There is provided a non-transitory computer readable media having stored thereon instructions for determining a control channel element (CCE) aggregation level for a user equipment (UE) in a physical downlink control channel (PDCCH). The instructions comprise obtaining radio base station (RBS) traces. The instructions comprise training, using first data obtained from the traces, a machine learning model to predict a probability of discontinuous transmission (DTX) “isDTX probability”. The instructions comprise inputting second data obtained from the traces into the first machine learning model, obtaining the isDTX probability and expanding the second data with the isDTX probability. The instructions comprise, for each probability threshold (PT) of a plurality of PTs and for each strategy of a plurality of strategies: selecting a subset of the second data having an isDTX probability greater or equal to the PT, selecting a data from the subset of data, best satisfying the strategy and using the data to train a classifier. The instructions comprise selecting one classifier. The instructions comprise using the classifier for determining the CCE aggregation level for the UE in the PDCCH.

There is provided a non-transitory computer readable media having stored thereon instructions for determining a control channel element (CCE) aggregation level for a user equipment (UE) in a physical downlink control channel (PDCCH). The instructions comprise providing traces, for training a machine learning model to predict a probability of discontinuous transmission (DTX) “isDTX probability”. The machine learning model is trained using first data obtained from the traces, the second data, obtained from the traces, is expanded with the isDTX probability obtained from inputting the traces into the machine learning model. For each probability threshold (PT) of a plurality of PTs and for each strategy of a plurality of strategies: a subset of the second data having an isDTX probability greater or equal to the PT is selected, a data from the subset of data, best satisfying the strategy is selected, and the data is used to train a classifier, thereby producing a plurality of classifiers. The instructions comprise obtaining the plurality of classifiers. The instructions comprise selecting one classifier. The instructions comprise using the classifier for determining the CCE aggregation level for the UE in the PDCCH.

The method, system and radio base station provided herein present improvements to the way control channel element and power allocation operate.

### BRIEF DESCRIPTION OF THE DRAWINGS

FIG. 1 is a schematic illustration showing an overview of PDCCH with CCE and PSD pre-configuration according to the prior art.

FIG. 2a is a block diagram illustrating an overall training process.

FIG. 2b is a block diagram illustrating an overall inference process.

FIG. 3 is a block diagram illustrating an overview process of trace data collection in RBS.

FIG. 4 is a block diagram illustrating in more details an example data collection process in RBS and an optional combined process with UEs.

FIG. 5 is a flowchart illustrating steps involved in data preprocessing and extraction of several features from the trace data to create train and compression datasets.

FIG. 6 is a table illustrating power discretization and cost of allocation.

FIG. 7 is a block diagram illustrating a general overview of an example augmentation unit for CCE allocation dataset.

FIG. 8 is a block diagram illustrating an example one-side augmenter.

FIG. 9 is a block diagram illustrating an example dual-side augmenter.

FIG. 10 is a flowchart illustrating the steps involved in training an ML model that determines the CCE/power allocation per transmission.

FIG. 11 is a flowchart illustrating the steps involved during the inference to determine the CCE/power allocation per transmission.

FIG. 12 is a block diagram illustrating an overall system for training and deployment.

FIG. 13a is a table illustrating prediction performance of the base model for different probability thresholds.

FIG. 13b is a table illustrating CCE and power utilization of the base model versus the product for different probability thresholds and selection strategies.

FIG. 14 is a block diagram illustrating the interplay among expansion, selection strategy and compression unit.

FIG. 15 is a flowchart for an example monitoring system.

FIG. 16 is a block diagram illustrating an example action mapping function.

FIG. 17 is a flowchart of a method for determining a control channel element (CCE) aggregation level for a user equipment (UE) in a physical downlink control channel (PDCCH).

FIG. 18 is a schematic illustration of a hardware in which steps and/or method described herein can be executed.

FIG. 19 is a schematic illustration of a virtualization environment in which the different steps and hardware components described herein can be deployed.

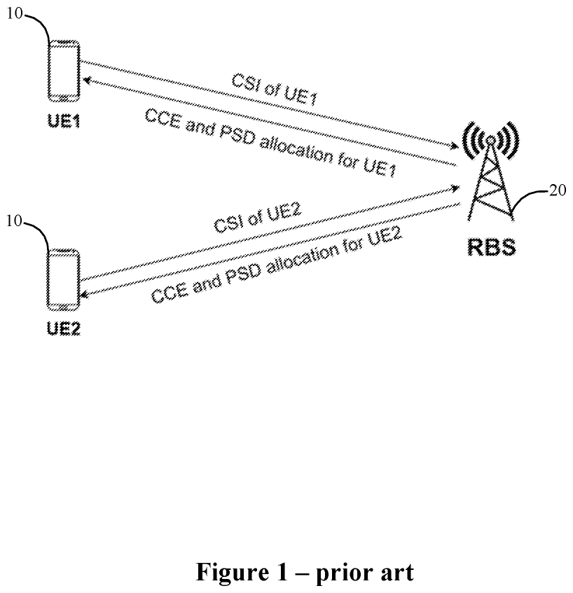

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

At least some aspects of the techniques described herein may be implemented using artificial intelligence, which comprises a variety of techniques as would be apparent to a person skilled in the art, including machine learning techniques. Machine learning techniques include Neural Network (NN), or Artificial Neural Network (ANN), and both terms may be used interchangeably herein. In some contexts, an Artificial Neural Network could include biological portions.

One of the challenges in a physical downlink control channel (PDCCH) is to determine the control channel element (CCE) aggregation level and, optionally, power spectrum density (PSD) for a user equipment (UE).

The optimal CCE/power selection is a difficult problem as it depends on many factors. Herein, “power spectrum density”, “PSD”, “power density” and “power” may be used interchangeably. It is not possible to know if a mapping that performs well in one environment will always perform well in another environment. Thus, the optimal mapping for the CCE/power density can vary vastly across different scenarios. It is expected that a static/global mapping sometimes exhibits inferior performance due to different deployments (e.g., urban vs rural), network configurations (time division duplex (TDD) vs frequency division duplex (FDD)), and even changes in traffic due to the type of day or other behavior in the network.

Currently, the existing solutions employ a static/global mapping between certain known parameters such as channel quality indicator (CQI) and CCE/power values. Since the number of potential configurations and deployment types are combinatorial and can change over time, it is nonoptimal to derive static/global mappings using conventional human intervention.

Consequently, there is a need for a solution such that the mapping could be derived dynamically and locally based on the local topology and the environment of the radio base station. Herein, an ML-based solution to this problem is proposed, which trains dynamic models based on the baseband traces collected from the surrounding environment of the radio base station.

The proposed solution applies machine learning algorithms and employs various features to determine CCE and PSD allocation in PDCCH in a baseband system, utilizing baseband traces collected from a radio base station in the field.

Machine learning techniques are data-driven and can dynamically learn different CCE/power input patterns across different real scenarios by analyzing a large volume of trace data automatically. One goal of the proposed solution is to minimize resource utilization (e.g., CCE and power) while maintaining a reliable connection.

The ML models are trained using subsets of features with various levels of complexity, selected from a larger feature set parsed from the baseband traces.

The diversity of models ensures the solution to be flexible, portable, and deployable as a product. The solution consists of multiple components such as data-preprocessing (e.g., traces filtering/joining, augmentation), model-training, and model-inference.

Some of the advantages of the proposed solution are as follows:
Improved Network performance (throughput, ping times, etc.) due to improved PDCCH performance.
Reduced operating expense (OPEX) for operators as a reduction of the need to adjust configuration parameters. This is because link adaptation parameters can be learned automatically from the field and through very small-grained deployments, rather than through expensive parameter sweep operations requiring significant oversight and human involvement.
Reduced product feature development costs as the impact of the new product features on PDCCH link adaptation can be learned automatically.
The ML-based solution allocates CCE/power in a smart way based on large trace data in real-time and can increase cell throughput by reducing CCE/power usage.
The ML-based solution provides dynamic feedback to PDCCH channel to adjust the upcoming network information and achieve more reliable connections for UEs in a PDCCH channel with a more accurate CCE/power allocations.
The ML-based solution enables on demand trade-off between cell throughput and reliability.

The proposed solution can be introduced to long term evolution (LTE)/new radio (NR) eNodeB (eNB)/gNodeB (gNB) as follows.
Introduction of dynamic loading of base models for CCE/power allocation in PDCCH within an eNB/gNB.
   a. Modifications to eNB/gNB to capture relevant ‘trace data’.
   b. The ML model is trained by extracting features from the captured trace data and then is loaded into eNB/gNB.
   c. The eNB/gNB uses the ML model to derive the near-optimal CCE/power allocation. This model includes both the mapping of features to relevant outputs but also which features are considered, and possibly any relevant preprocessing steps needed.
   d. Optional: Application of a feedback loop in determining the preferred configuration for parameters and then loading the appropriate model in terms of aggressiveness and selection strategy.
Introduction of a monitoring system to detect if the model is inaccurate and needs to be updated/retrained, e.g., by monitoring the block error rate (BLER) in PDCCH. If the BLER is above the acceptable level, the retraining process can be triggered. The discontinuous transmission (DTX) predictability can also be monitored.

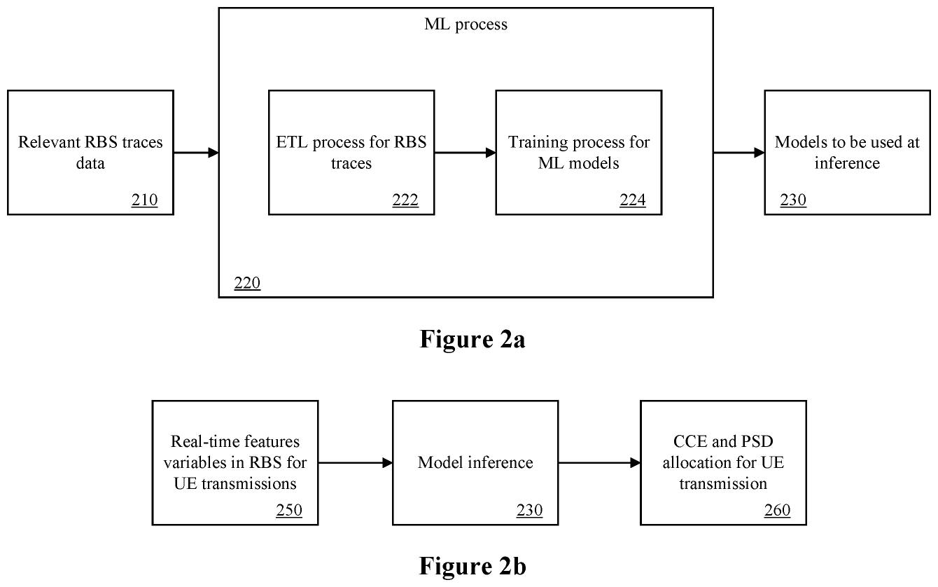

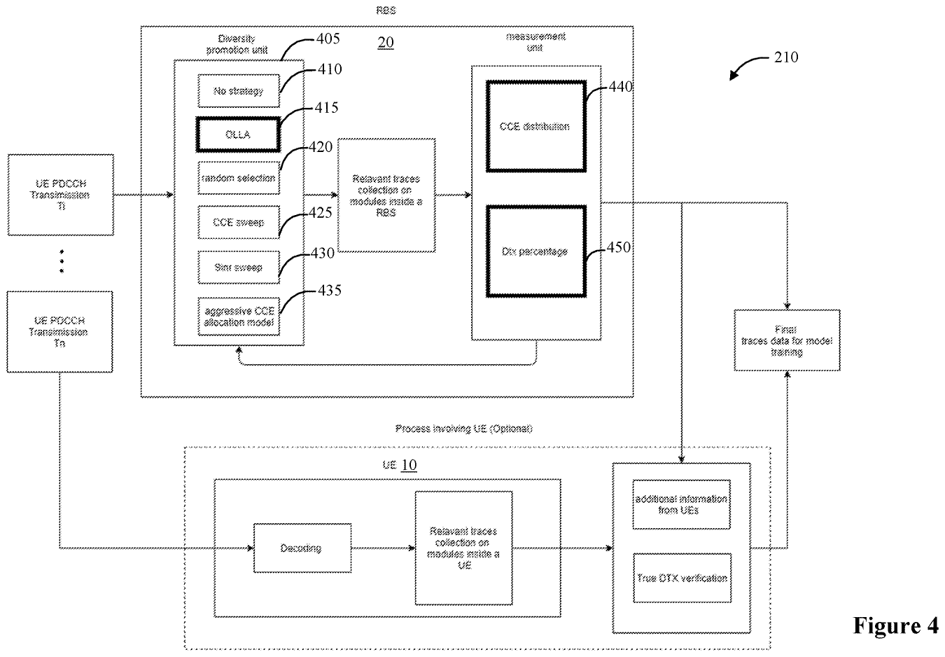

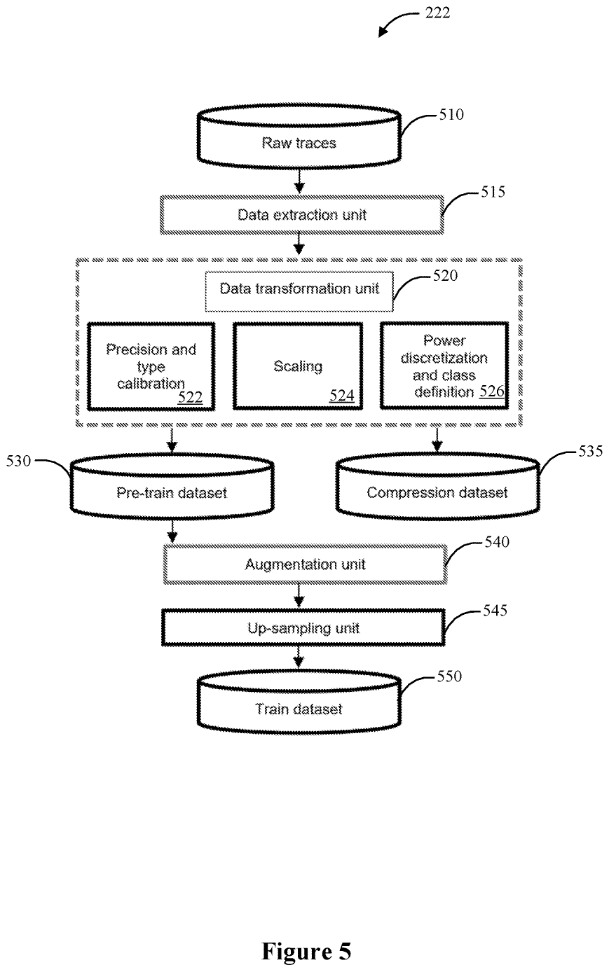

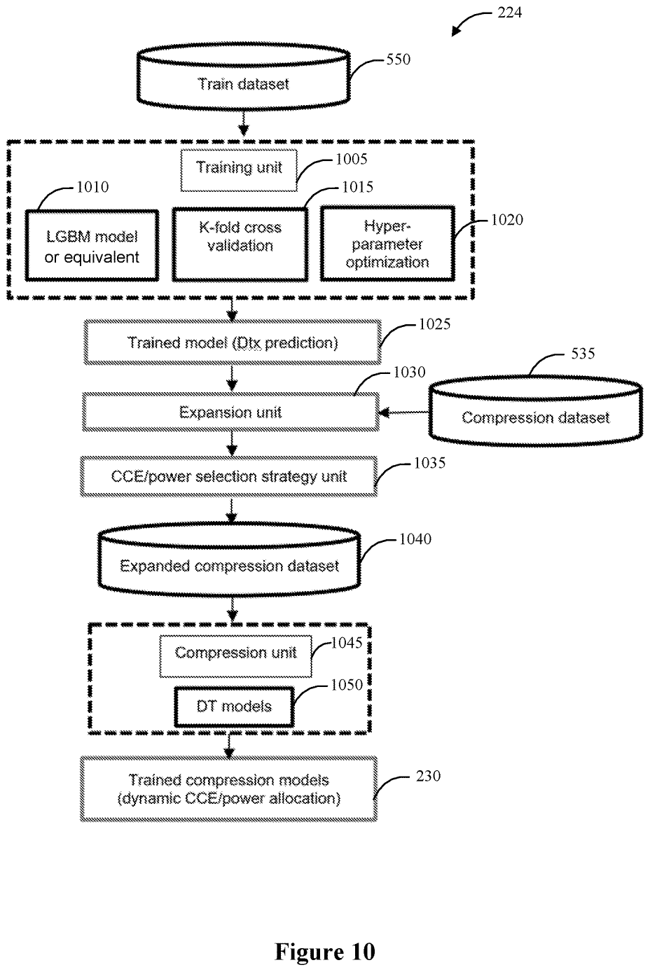

FIGS. 2a and b describe the overall process for model training and inference. The model training process is presented in FIG. 2a. During the training, the radio base station (RBS) traces data 210 are the input to the ML process 220 and will be discussed in detail in relation with FIG. 4. The overall ML process encapsulates the extract, transform and load (ETL) process for RBS traces 222 and the training process for ML models 224. Those are described in more details in relation with FIGS. 5 and 10, respectively. The output of the ML process is the models used for inferences 230.

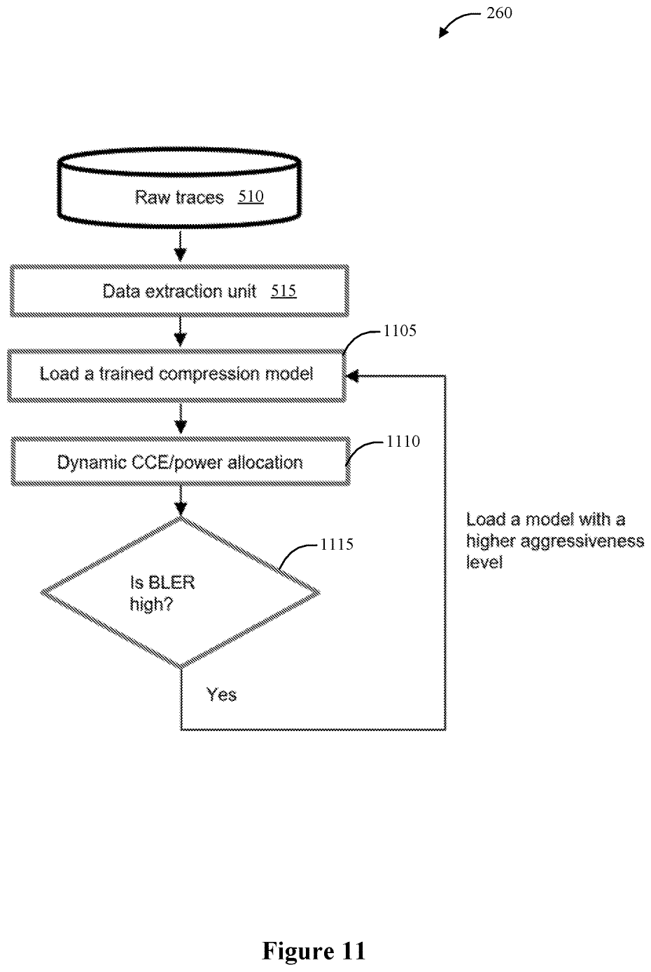

The inference process is presented in FIG. 2b. At the inference, real-time feature variables in the RBS are used as input 250 to the models obtained from the training process 230. The output of the models is the CCE and PSD allocation for UE transmissions 260. However, depending on the needs of the system, it is possible to also have only one of CCE and PSD as output. This is discussed in more details in relation with FIG. 11.

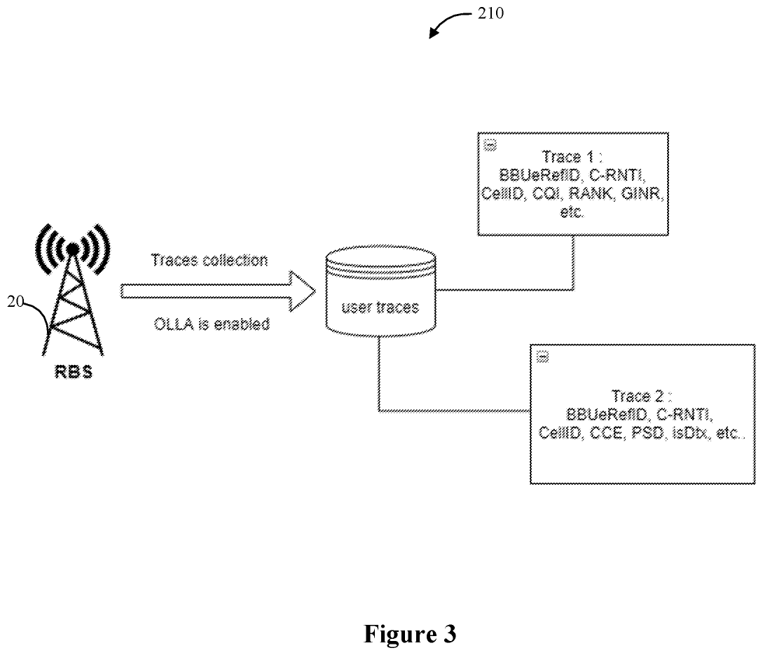

Turning to FIG. 3, during the traces collection process 210, the eNB/gNB 20 is modified to capture relevant trace data, of which examples are provided further below. Multiple traces from different components/entities on the RBS can be captured. The final trace data should contain relevant information for ML model training happening in the later step.

FIG. 4 is a block diagram/flowchart illustrating the data collection process 210 in RBS 20 and, optionally, in UE 10. In most cases, the Outer Loop Link Adaptation (OLLA) 415 should be enabled to promote diversity in the CCE allocation in the trace data. There are other options in the diversity promotion unit 405, for example, a sweep on CCE level 425 (e.g., CCE 1 to CCE 8) can be performed to capture the behavior in PDCCH transmissions. Random selection 420 on CCE with probability can also be used. Another approach is to modify the system constants to add an offset or perform a sweep in signal to interference & noise ratio (SINR) 430, which will be translated into the diverse CCE allocations. A more aggressive model 435 (allocating less CCE than the original allocation algorithm) can also be loaded initially solely for purposes for the traces collection. This model can be derived from simulation (e.g., a non-ML model) or from ML training from previous data. A no strategy 410 choice is also available.

Once the traces are collected and processed for analysis 210, it should be possible to measure the CCE distribution 440 and DTX rate 450 in the data. For that purpose, a predetermined distribution could be targeted, e.g., above 50% of the allocation should use CCE 2. A DTX rate target can also be set to generate better training data with a higher DTX rate. Options can be adjusted in the diversity promotion unit until those targets are met.

Alternatively, the traces can also be captured from UE devices 10, to add additional information for testing and improving the training dataset. From the UE, information about when the UE decoded something could be obtained (as well as potentially what was decoded) with the goal to avoid false DTX detections (which should be rare). This additional information could reduce the false DTX in the training dataset and consequentially improve data quality for model training. Other information such as SINR on the PDCCH, predicted BLER, noise power estimates on PDCCH, power received on DMRS not only can also help provide extra UE side information in the test data, but improve the data quality, e.g., enable additional data augmentation without trial and error, since there are strong correlations between CCE and SINR on the UE side. The traces collected on the UE side should be stored in the operating system (OS) space on the UE side and can be transferred to RBS using OTT methods (hypertext transfer protocol (HTTP), file transfer protocol (FTP), etc.).

FIG. 5 is a flowchart illustrating steps involved in data preprocessing and extraction of several features 222 from the trace data to create train and compression datasets. Raw traces 510 are traces that are collected by a service provider and that contain information regarding the UE activities and interactions with the RBS in the scope of a baseband unit. The file size is often in gigabytes if not terabytes with millions of instances of transmissions between UEs and the RBS.

Raw traces 510 are the input of a data extraction unit 515. If the raw traces 510 are encoded, they need to be decoded into a readable format such as JavaScript Object Notation (JSON) for better processing. A software module will then extract relevant information such as control channel element (CCE), power spectrum density (PSD), channel quality indicator (CQI), Rank, Signal/Gain to interference plus noise ratio (SINR/GINR), UE pathloss, discontinuous transmission (DTX), etc., from the traces. Furthermore, the traces are joined together according to their timing and causal relationship. The final output is a tabular dataset consisting of transmissions between UEs and the RBS.

The tabular dataset is then input into a data transformation unit 520. The data transformation unit 520 calibrates the precision of the data 522, that is needed due to datatypes of different precision that can be used at training vs inference time. Scaling 524 is performed on the features, as necessary, to minimize the discrepancy between the training and inference. Furthermore, the data types on other features are adjusted accordingly, to save memory and to speed up data preprocessing and training. For example, there is no need to use Float64 if the range of values is such that they can be represented by Int32. Extensive object serialization/deserialization is also used throughout the code to save memory and reduce the overall runtime. The output of this unit should be “the original dataset”.

The power discretization and class definition 526 is explained using an example. First, all the CCE values that are used are found. In an example dataset, four CCE values (1, 2, 4, 8) are used. Then, for each CCE value, the minimum power (m) and maximum power (M) are found, and five equidistant points are selected in the interval [m, M] including the endpoints. In other words, the power is discretized. In practice, it is sometimes better to clip the maximum power M when there is an upper limit in power allocation. For example, an upper bound of U=6000 can be set and then M_clipped=minimum (M, U) can be set. The number five here is recommended by a subject matter expert, but it can be decreased or increased depending on the targeting granularity. In the eight CCE case, only one power level is used.

The (CCE, power) pairs/levels are then saved in a dictionary, called class dictionary, in which each class represents a combination of CCE and power. In a separate dictionary, called cost dictionary, the (CCE, power) pairs are min-max scaled to be map in a unit interval and then the cost of the allocation is calculated as follows:

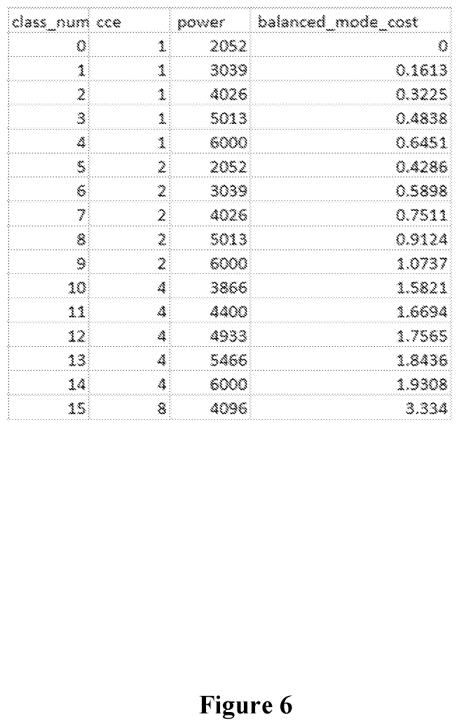

Cost=CEE_weight×CCE_scaled+power_weight×power_scaled

where CEE_weight and power_weight are predefined parameters with values in the unit interval. An example of the power discretization and cost for each allocation class is shown in table 3, in FIG. 6.

Returning to FIG. 5, the pretrained dataset 530 is created by adding the (CCE, power) levels as separate columns to the original dataset. For example, if the original dataset has 100 rows, and there are 15 levels, then the new dataset will have 1500 (i.e., 15×100) rows.

The compression dataset 535 is created from the original dataset exactly as the pretrained dataset. The original dataset is split through stratified sampling, 70% for the pretrained dataset and 30% for the compression dataset. This dataset is called “compression” dataset because it will be used for training a second model (compression model). This dataset is not used for training the first model and it is not augmented or up sampled. It should be understood that the 70%-30% is an example and other ratios could be used.

The augmentation unit 540 takes as input the pretrained dataset. The augmentation is performed according to the boolean values of discontinuous transmission (DTX) parameter. In general, a DTX value of zero is associated with low block error rate (BLER) values, and a DTX value of one is associated with high BLER values. If the DTX value of a (CCE, power) pair is zero, then the DTX values of all greater pairs is set to zero as well. Similarly, if the DTX value of a (CCE, power) pair is one, then the DTX values of all smaller pairs is set to one as well. Here, greater and smaller are defined in terms of product/coordinate-wise order. A pair (a₁, b₁) is smaller than a pair (a₂, b₂) if a₁<=a₂ and b₁<=b₂ and is greater if a₁>=a₂ and b₁>=b₂. The main purpose of the augmentation unit 540 is to reduce the imbalance ratio by adding more labels with isDTX=1.

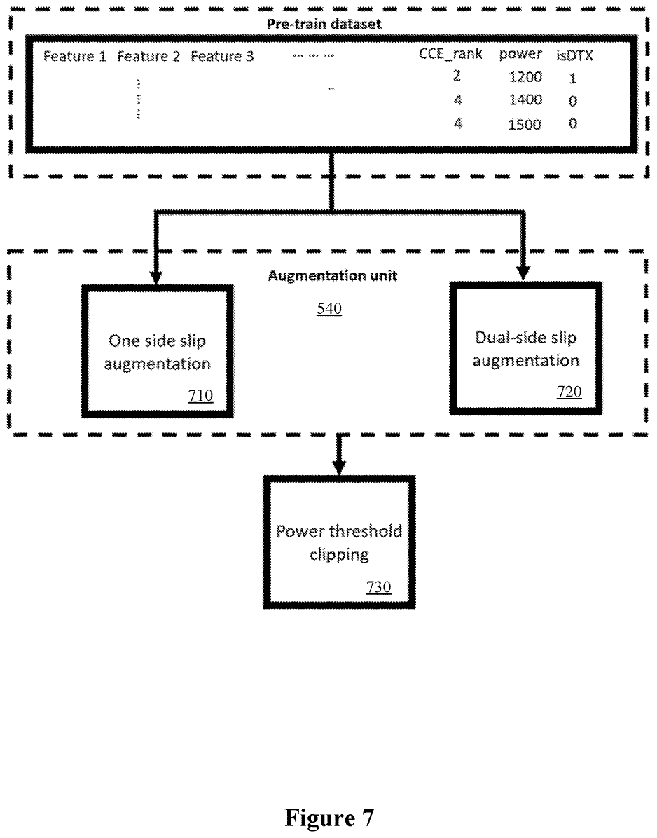

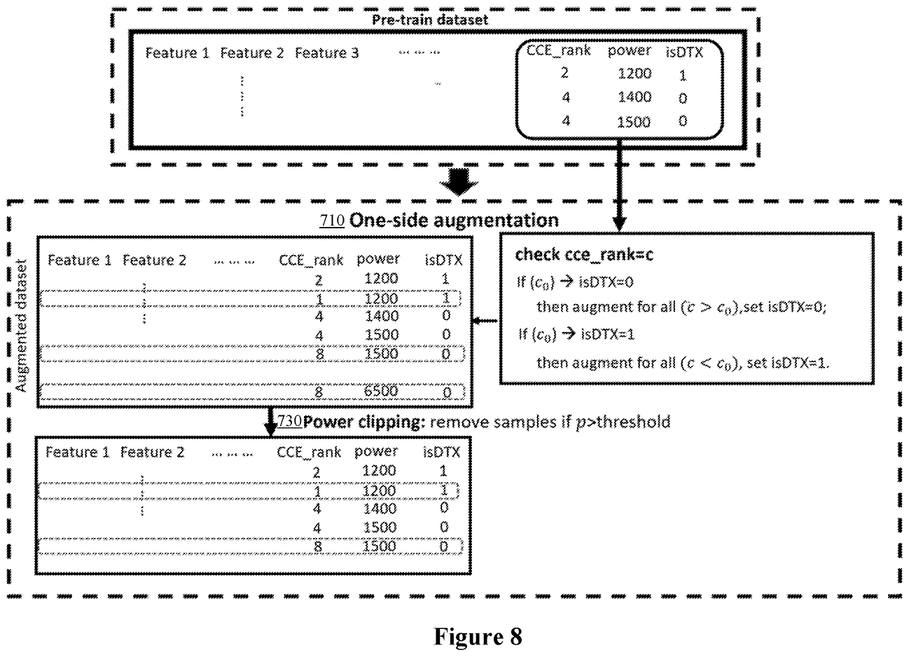

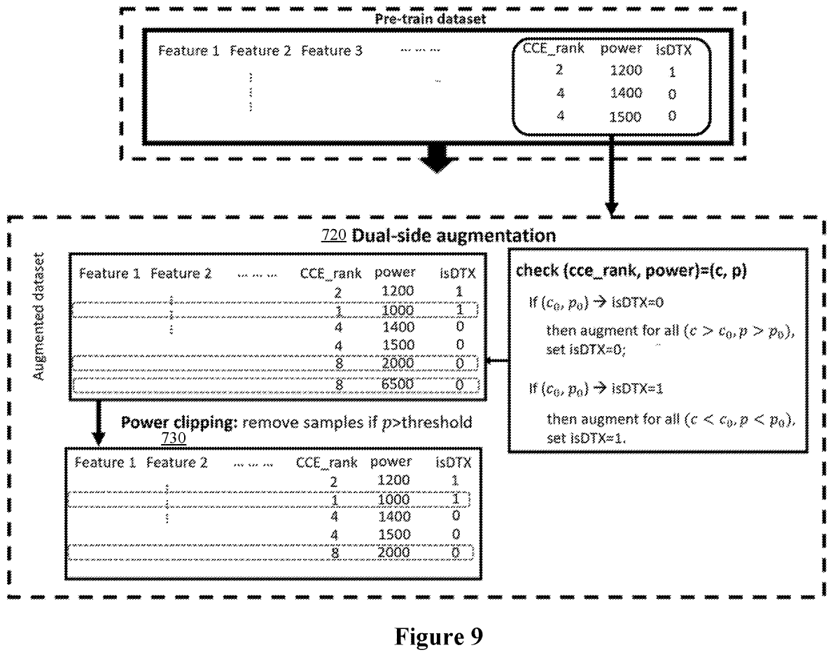

The augmentation unit 540 is discussed in further details in relation with FIG. 7, which provides a general overview of augmentation unit for a CCE allocation dataset. The augmentation unit contains three sub-modules: a one-side slip augmenter 710, a dual-side slip augmenter 720 and the output of the augmentation unit is then fed into a power threshold clipping module 730. FIGS. 8 and 9 describe how the augmenters work for the CCE dataset.

FIG. 8, illustrating the one-side augmenter 710, shows how to augment data samples by cce_rank. In this specific scenario, if the value of a cce_rank c₀∈{1, 2, 4, 8, 16} causes isDTX=0, it is true that all values with c>c₀ will still cause isDTX=0; while if c₀∈{1, 2, 4, 8, 16} causes isDTX=1, all values of c<c₀ will yield isDTX=1. Therefore, data samples can be augmented based on the two factors, as shown in the figure. If (c₀=2) causes isDTX=1, (c=1<c₀) will also yield isDTX=1; if (c₀=4) causes isDTX=0, (c=8>c₀) will also yield isDTX=0. After augmentation, power clipping 730 is applied to remove any power which is larger than a pre-defined threshold. The threshold can be determined from field tests or pre-analysis from historical data. For example, all samples with power greater or equal to 6500, after augmentation, are removed.

FIG. 9, illustrating the dual-side augmenter 720, shows how to augment data samples by (cce_rank, power) pairs. In this specific scenario, if the pair value of (cce_rank c₀∈{1, 2, 4, 8, 16}, power=p₀) causes isDTX=0, it is true that all values with (c>c₀, p>p₀) will still cause isDTX=0; while if the pair value of (c₀∈{1, 2, 4, 8, 16}, power=p₀)) causes isDTX=1, all values of (c<c₀, p<p₀) will cause isDTX=1. Therefore, data samples can be augmented as shown in the figure. If (c₀=2, p₀=1200) causes isDTX=1, (c=1<c₀, p=1000<p₀) will also yield isDTX=1; if (c₀=4, p₀=1500) causes isDTX=0, (c=8>c₀, p=2000>p₀) will also yield isDTX=0. After augmentation, power clipping 730 is applied to remove any power which is larger than a pre-defined threshold. The threshold can be determined from field tests or pre-analysis from historical data. For example, all samples with power>6500 after augmentation are removed.

Returning to FIG. 5, the up-sampling unit 545 takes the output of the augmentation unit 540 as input. The up-sampling unit 545 employs the synthetic minority oversampling technique (SMOTE), which is a well-known technique in the literature, to add synthetic samples to the dataset to increase the size of minority samples. The train dataset 550 is the output of the up-sampling unit 545, i.e., it is the augmented and up-sampled dataset that is used for training a model.

FIG. 10 is a flowchart illustrating the steps involved in training an ML model 224 that determines the CCE/power allocation per transmission.

A training unit 1005 takes as input the training dataset 550. In the training unit 1005, a light gradient boosting machine (LGBM) model 1010, which is a tree-based learning algorithm, or any other equivalent model, is trained. LGBM is a successor to extreme gradient boosting machine (XGBM), but it has a smaller training/inference runtime, higher efficiency, lower memory usage and occasionally better accuracy. The input features to the model include CCE, power, GINR, OLLA adjustment, UE pathloss, current rank, etc. More features can be added as well (see the intermediate and advanced models further below). The LGBM can be trained either with a cross-entropy (CE) loss or a focal loss which is a variation of CE loss.

The output of the training unit is a trained model 1025 and the output of the trained model 1025 is the predicted DTX value which is expressed as a probability pair (p₁, p₂) where p₁ is the probability of DTX value to be equal to zero and p₂ is the probability of DTX value to be equal to one. K-fold cross validation 1015 is also used for training. K is set to ten and the best model is chosen according to the area under the receiver operating characteristic (ROC) curve (AUC) performance metric. The hyperparameters of a light gradient-boosting machine algorithm are used, but an option for Bayesian hyperparameter optimization using a Bayesian optimization algorithm was also implemented. If the user decides to use hyperparameter optimization 1020, then the following hyperparameters are selected by the Bayesian optimization algorithm instead:
n_estimators,max_depth, num_leaves,learning_rate,feature_fraction,bagging_fraction, bagging_freq,min_sum_hessian_in_leaf,min_gain_to_split,lambda_l1,lambda_l2,pat h_smooth,extra_trees.

The trained model 1025, which is the output of the training unit 1005, i.e., the best LGBM model, is saved to a non-transitory storage, such as a disk.

The expansion unit 1030 receives the trained model 1025 and the compression dataset 535 as input. Then, it applies the trained model 1025 against the compression dataset 535, saves the p₁ (the probability of DTX value to be equal to zero) values in a separate column and expands the compression dataset 535 by adding this column to it.

The selection strategy unit 1035 can be seen as a rule-based model. The input is the expanded dataset that was created by the expansion unit 1030. The column that contains the p₁ value can be binarized by a probability threshold and the binary values can be considered as the predicted DTXs. If p₁>=threshold, the DTX is set to zero and is set to one otherwise. However, it is not clear what probability threshold is optimal a priori. Therefore, a list of probability thresholds is considered. In the implementation, nine probability thresholds, from 0.1 to 0.9, are considered. Each probability threshold corresponds to an aggressiveness setting. The higher the aggressiveness, the lower the probability threshold.

One example object could consist of minimizing both CCE and power in instances whose DTX values are zero. Since there are two objectives (i.e., CCE, and power), first, the set of Pareto optimal instances per each feature vector X is found. For example, assuming X consists of two features, CQI and rank, for X: [CQI=6, rank=1], there could be the Pareto set {(CCE=2, power=6000), (CCE=4, power=4000), (CCE=8, power=2000)} where the DTX values for (CCE, power) pairs are one. A model (called a compression model), that takes X as the input and outputs a single (CCE, power) pair as the optimal pair, is desired. Therefore, a way (strategy) to map the Pareto set to a single pair is needed. Since such a mapping depends on the preferences of the service provider, flexibility is given to the service provider by proposing three different strategies.

The first strategy is called “minimize CCE”. In the previous example, the pair (CCE=2, power=6000) is selected according to this strategy. The second strategy is called “minimize power”. In the previous example, the pair (CCE=8, power=2000) is selected according to this strategy. The third strategy is called “balanced”. In the previous example, the pair (CCE=4, power=4000) is selected according to this strategy. The balance strategy is determined by inputting CEE_weight and power_weight parameters in the following cost formula:

$$Cost = CEE\_weight \times CCE\_scaled + power\_weight \times power\_scaled .$$

In summary, given a feature set (e.g., CQI and rank), for each probability threshold and for each strategy, the optimal (CCE, power) pair per instance is found and is added to the expanded dataset as separate columns.

The expanded compression dataset 1040 is the output of the selection strategy unit 1035, i.e., it is the dataset that has the predicted DTX values per probability threshold and optimal (CCE, power) pairs per probability threshold and per selection strategy.

In the model compression unit 1045, a decision tree (DT) is trained to learn/imitate each selection strategy per probability threshold, i.e., 27 (9×3) compression models are trained. The input features are at minimum CQI and rank (not CCE and power), but more features can be added. The optimal (CCE, power) pairs are label encoded (i.e., mapped to integer values from 1 to the number of classes). This label encoding is saved to the disk to enable calculating the inverse mapping (from labels to (CCE, power) pairs) later. The DT model 1050 is called a compression model as it is compressing what has been learned from the light gradient-boosting machine algorithm model and the rule-based strategy selection model in the form of a small decision tree to lower the memory cost. A person skilled in the art would understand that other types of models could alternatively be trained.

The trained compression models 230 are the output of the compression unit 1045; each takes the form of a decision tree that takes a feature vector (e.g., CQI and rank) as input and gives a class number as output which in turn is mapped to the optimal (CCE, power) pair by the use of the saved label encoding dictionary.

Turning to FIG. 11, the use of raw traces 510, data extraction unit 515, and compression models 230 are explained in the context of inference. During the inference, there are twenty-seven compression models to choose from 1105 depending on the optimization preferences of the operator. The output of the selected compression model is a dynamic/local (CCE, power) pair recommendation 1110 which is learned from the field/real data by the proposed machine learning solution. If BLER is too high 1115, the operator can load a model with a lower aggressiveness (higher probability threshold) to lower the BLER at the cost of increasing resource utilization. Furthermore, the ML models can be retrained by employing a feedback loop.

In contrast, the current product (existing solution) can only recommend a CCE value statically and globally (i.e., the mapping is fixed for all locations, all traffic loads, etc.). The fixed mapping/heuristic is not learned from the field/real data, but it is derived through some simulations (artificial data).

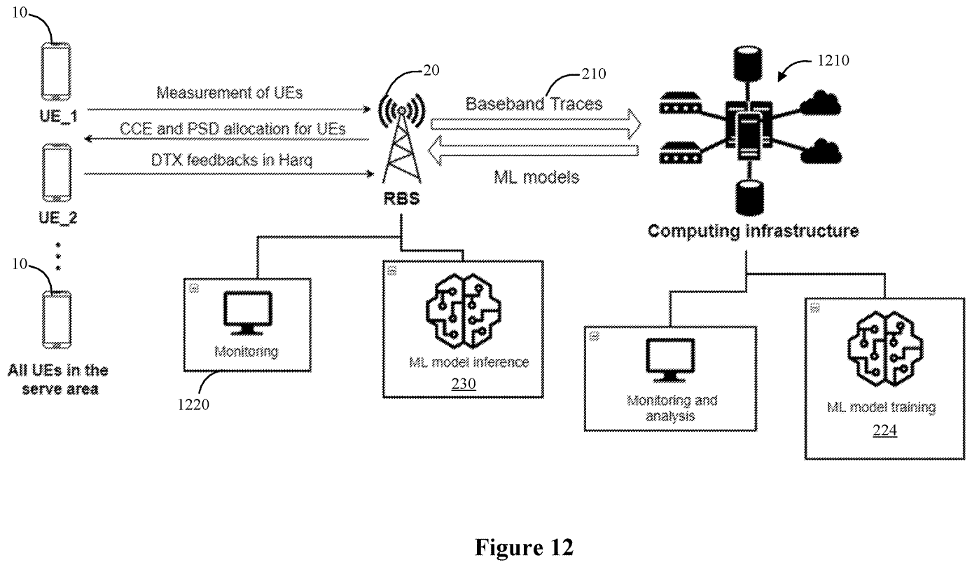

Referring to FIG. 12, the overall ML system architecture is shown. The system consists of the following processes.

Baseband traces 210 of UEs 10 are collected for ML model training 224. These traces contain information regarding transmissions between UEs and RBS 20. The traces include the CCE, PSD, DTX, UE pathloss, instance time and all other necessary information for ML data construction and ML model training. The collection of the baseband traces could occur on demand or periodically depending on the retraining strategy.

Once the traces are collected in RBS, they are transferred to the computing infrastructure 1210 for the ETL process 222 (see FIG. 2), which is illustrated in more details in FIG. 5. The computing infrastructure can include computing resources connected to the RBS, the options include, but are not limited to data centers, clouds, local servers etc. Once the traces are processed to generate structured ML data, offline ML model training takes place 224 to consume these data. The training process is shown in FIG. 10.

After the ML model is trained, it is loaded onto the baseband software for inference 230. The details are described in FIG. 11.

A monitoring platform 1220 should be in place to detect concept drift and data drift of the model. The monitoring can occur directly inside the RBS or externally to the RBS. If the model performance degrades to a certain threshold, a retraining should be triggered.

In a test implementation, a dataset was used which consisted of a 1 TB size of traces collected from an RBS. Nine probability thresholds were considered (aggressiveness levels from 0.1 to 0.9), as well as three selection strategies (minimize CCE, minimize power, balanced) and three feature sets as follows.

A base model included the features: GINR, OLLA adjustment, UE pathloss, current rank, number of downlink control information (DCI) bits, UE qam256 capability, time of the day.

Additional features were included in the intermediate model: wideband CQI, SINR, last rank, current precoding matrix indicator (PMI), last PMI.

Further additional features were included in the advanced model: wideband CQI, SINR, last rank, current PMI, last PMI, cell identifier (ID), new data flag (NDF), modulation and coding scheme (MCS), CCE Index, number of resource block allocation (RBA) bits, reference signal received power (RSRP), reference signal received quality (RSRQ), cell loading information, target PDCCH BLER, slot type (multicast broadcast single frequency network (MBSFN) etc.), uplink (UL) measurements such as interference covariance, noise power etc.

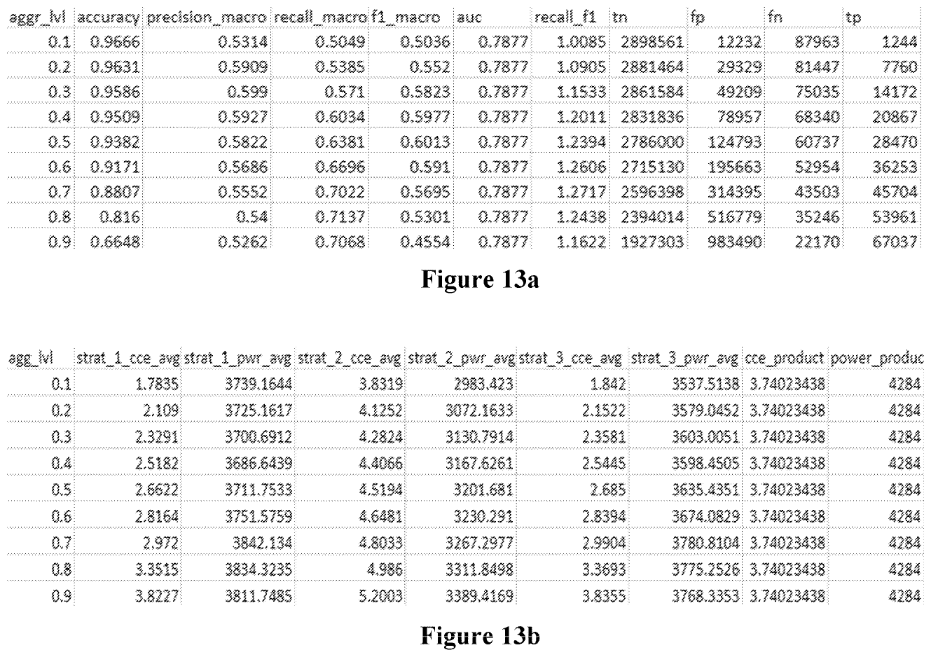

The table in FIG. 13a illustrates the prediction performance of the base model for different probability thresholds. In the table agg_lvl stands for “aggressiveness level” and refers to the probability threshold. Tn, fp, fn, and tp stand for true negatives, false positives, false negatives, and true positives. AUC refers to the area under the ROC (receiver operating characteristic) curve. Macro precision, recall, and F1, are calculated metrics for each label first and then their unweighted mean is found. Recall_f1 is the summation of macro recall and macro F1.

The table in FIG. 13b illustrates the (CCE, power) utilization of the base model versus the product for different probability thresholds and selection strategies. In the table, strat_# denotes the strategy number which could be one of the three predefined strategies. Similarly, strat_#_cce or strat_#_power refers to the mean CCE or power utilization corresponding to the selected strategy. CCE_product and power_product refer to the mean CCE and power utilization corresponding to the existing product baseline (the static mapping).

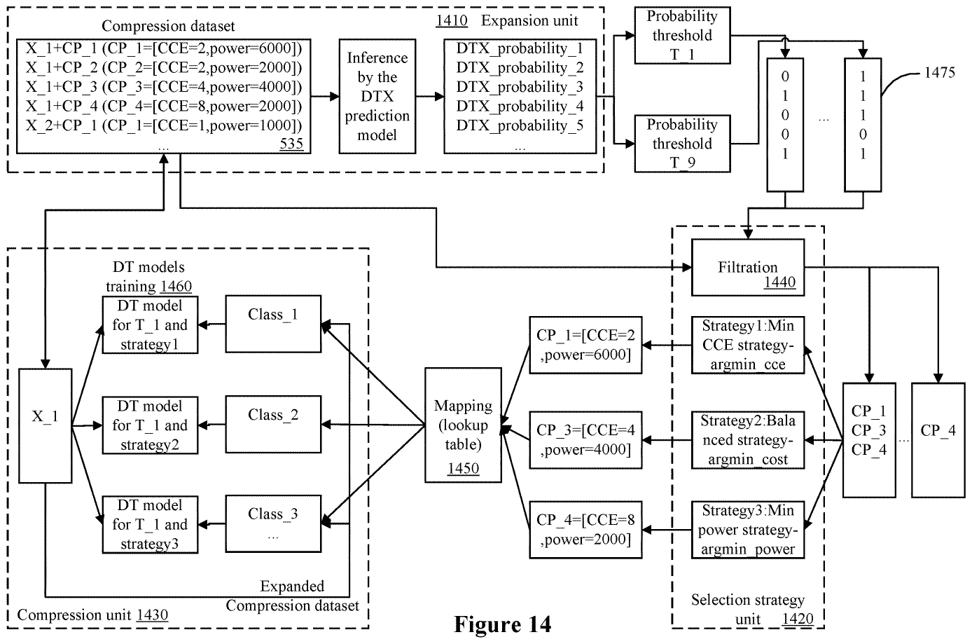

FIG. 14 illustrates the interplay among expansion unit 1410, selection strategy 1420, and compression unit 1430. From the previous steps, a trained DTX prediction model and a compression dataset 535 were obtained. The input to the DTX prediction model is a feature vector of the form [X[0], X[1], . . . , X[N], CCE, Power], where N is the size of X and X can include features such as CQI, rank, etc., and the output is a probability vector [p₁, p₂]. There is interest only in p₁, which is the probability of DTX to be zero. As mentioned previously, p₁ is binarized with a probability threshold Tᵢ, where Tᵢ can take values in [0.1, 0.2, . . . , 0.8, 0.9].

The binary DTX values 1475 and the compression dataset are the input to the selection strategy unit 1420. Since there is interest only in zero DTX values, the samples where the predicted DTX value is one are filtered out 1440. The remaining samples are the input to the three different selection strategies that were described previously. Each selection strategy assigns the optimal (optimal according to the strategy) CCE and power pair to the vector X. For the samples where their predicted DTX value is one, there is no need for a selection strategy, but rather a fixed rule, e.g., a fixed (CCE, power) pair can be assigned to these samples.

Next, a lookup table 1450 is created in which a class label Cᵢ is assigned to each selected (CCE, power) pairs. The features Xᵢ and their corresponding class labels Cᵢ constitute an expanded compression dataset (expanded refers to the fact that the features are expanded with class labels thanks to the DTX prediction model, the probability threshold, and the selection strategy). The expanded compression dataset is used for training decision tree (DT) models 1460 where a DT model is trained per probability threshold Tᵢ and selection strategy j, where i=1, . . . , 9 and j=1, . . . , 3. During inference, the operator chooses a DT model, the DT model takes Xᵢ as input and outputs a class label Cᵢ, then the lookup table maps/translates the class label Cᵢ to an optimal (CCE, power) pair.

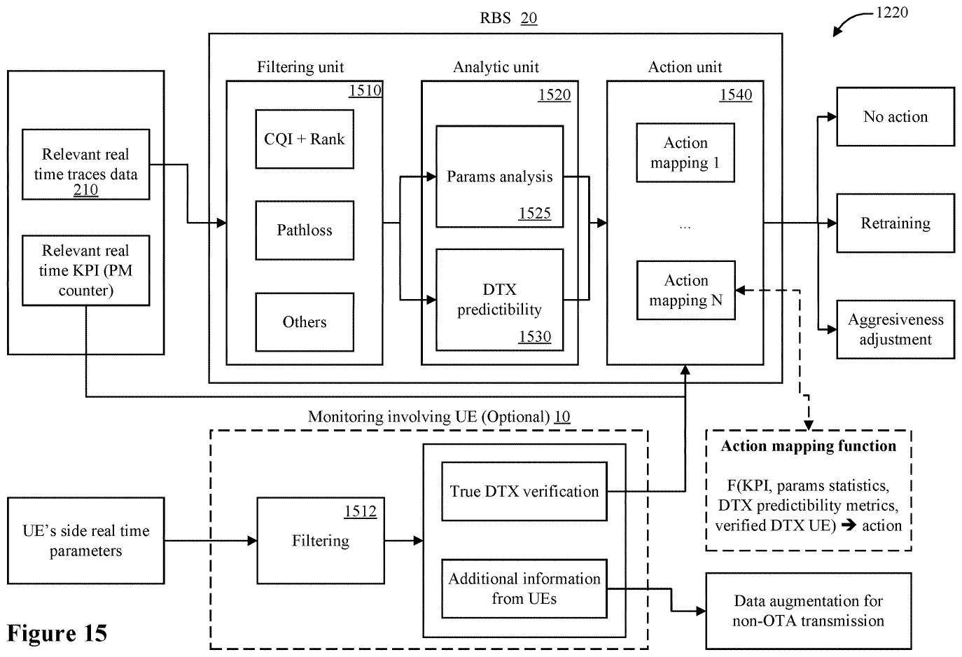

FIG. 15 illustrates the workflow for the monitoring system 1220. On the RBS side, both real time traces data 210 and real time KPI (e.g., pm counters in baseband) can be used for monitoring. Due to the large amount of traces data, a filtering unit 1510 can be used for targeting a specific area of interest in traces data. For example, one can use a CQI+Rank filter while others could use a pathloss filter to remove transmission having unreasonable low signal quality. The filtered traces data are the input to the analytics unit 1520 in the next step.

There are two components in the analytic unit: parameter analysis 1525 and DTX predictability component 1530. In the analytic unit, parameters of interest are analyzed. The aggregated statistics, e.g., the average CCE utilization, DTX rate, etc., are then used as input to the action unit 1540. In the DTX predictability component, the current DTX prediction model trained in FIG. 10 is evaluated upon the latest traces data. The machine learning metrics, e.g., F1 score, Recall, AUC, etc., can then be calculated, and passed to the action unit.

The action unit 1540 then performs action selection among the three actions: no action, retraining, and aggressiveness adjustment. Multiple mapping functions/options can be used. Each mapping function takes the input from the KPI, parameter statistics, DTX predictability metrics, UE verified DTX to output the action. For instance, one mapping function is shown in FIG. 15. However, other mapping functions could also be implemented if required.

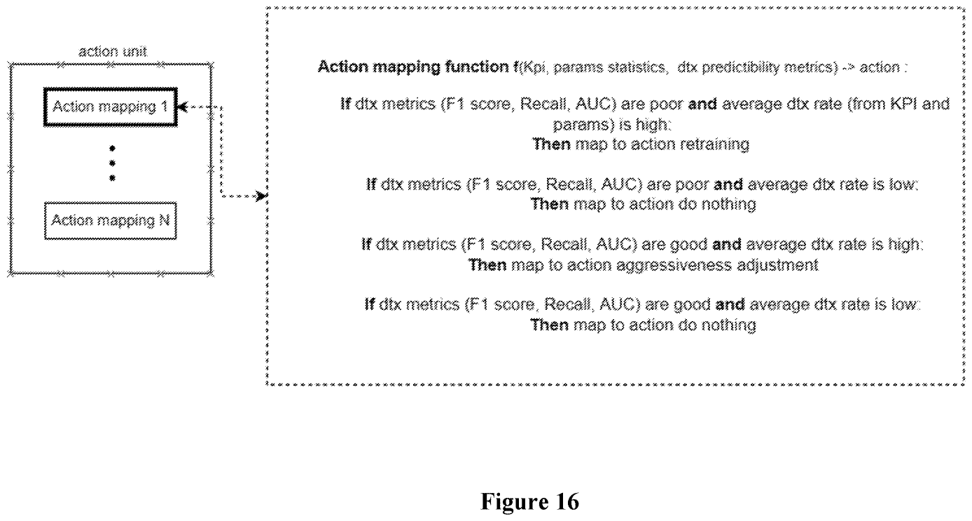

It is also possible to target a device side monitoring in which UEs can keep track of relevant parameters as well as PDCCH SINR estimates and detect if the PDCCH is overengineered and provide information to operators or other 3rd party devices. A filtering unit 1512, like the one in RBS, can be used to filter unwanted transmission. The filtering option can be aligned with the RBS. The true DTX information can be extracted based on PDCCH SINR estimates from the filtered transmission, which then can be input to the action unit in RBS (illustrated in FIG. 16). Like the UE side's traces collection in FIG. 4, the monitored data from UE devices can add additional information for testing and improving the training dataset, such as reduce the false DTX in the training dataset, provide extra UE side information in the test data and enable data augmentation without trial and error, since there are strong correlations between CCE and SINR on the UE side. All traces data collected from the monitoring step can be used for retraining the model without a separate data collection process.

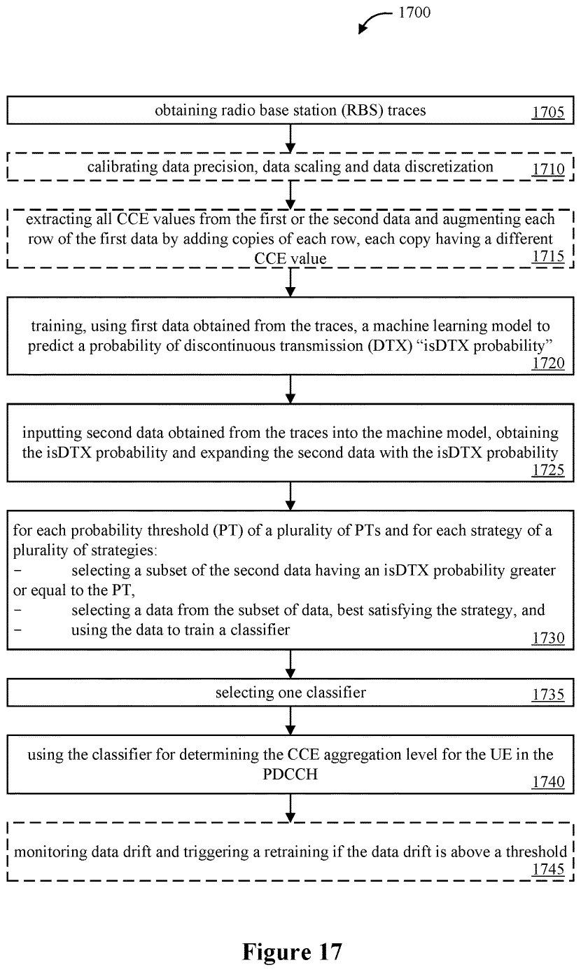

Turning to FIG. 17, there is provided a machine learning (ML)-based method 1700 for determining a control channel element (CCE) aggregation level for a user equipment (UE) in a physical downlink control channel (PDCCH). The method comprises obtaining, step 1705, radio base station (RBS) traces. The method comprises training, step 1720, using first data obtained from the traces, a machine learning model to predict a probability of discontinuous transmission (DTX) “isDTX probability”. The method comprises inputting, step 1725, second data obtained from the traces into the machine learning model, obtaining the isDTX probability and expanding the second data with the isDTX probability. The method comprises, for each probability threshold (PT) of a plurality of PTs and for each strategy of a plurality of strategies, step 1730, selecting a subset of the second data having an isDTX probability greater or equal to the PT, selecting a data from the subset of data, best satisfying the strategy and using the data to train a classifier. The method comprises selecting, step 1735, one classifier. The method comprises using, step 1740, the classifier for determining the CCE aggregation level for the UE in the PDCCH.

Herein, selecting data best satisfying a strategy means selecting data that corresponds the closest to the strategy, as explained in detail and exemplified with reference to the figures. For example, for the strategy “minimize CCE”, the data best satisfying the strategy is the data having the smallest CCE.

The traces may be obtained from different components or entities of the RBS. The traces may be obtained using a strategy selected from: no strategy, Outer Loop Link Adaptation (OLLA), random selection, CCE sweep, signal to interference & noise ratio (SINR) sweep or an aggressive CCE allocation model.

The trace data may include two or more data selected from: CCE, power spectrum density (PSD), channel quality indicator (CQI), Rank, SINR, Gain to interference plus noise ratio (GINR), UE pathloss, and DTX. The trace data may further include any additional data selected from: PMI, cell identifier (ID), NDF, MCS, CCE Index, number of resource block allocation (RBA) bits, OLLA info, Received Signal Strength Indicator (RSSI), Reference Signal Received Power (RSRP), Reference Signal Received Quality (RSRQ), cell loading information, target PDCCH BLER, slot type (MBSFN etc.), UL measurements such as interference covariance, noise power, and all the previously mentioned features of both the present and the past (past measurements, e.g., the current CQI, the past CQIs), etc.

The first and the second data obtained from the traces may comprise a subset of features selected from the traces.

The method may further comprise, for obtaining the first or the second data from the traces, calibrating, step 1710, data precision, data scaling and data discretization.

The method may further comprise, for obtaining the first or the second data from the traces, extracting, step 1715, all CCE values from the first or the second data and augmenting each row of the first data by adding copies of each row, each copy having a different CCE value.

The machine learning model to predict the isDTX probability may be an artificial neural network (ANN). In one example embodiment, the following configuration was used: n_estimators=800, max_depth=10, num_leaves=64, learning_rate=0.005, min_child_samples=200, eval_metric=‘auc’, early_stopping_rounds=100.

The method may further comprise monitoring, step 1745 data drift and triggering a retraining if the data drift is above a threshold.

The method may also be used for determining a power spectrum density (PSD) for the UE.

The plurality of PTs may comprise nine values, between 0 and 1, and the plurality of strategies may comprise “minimize CCE”, “minimize PSD” and “balanced”. It should be understood, however that more PTs (aggressiveness levels) could be used, such as 20 or 30 levels, if a finer granularity is needed. The gNB may select different models on the fly depending on what resources are limited at a given time. For example, in some time slots the gNB may determine that CCEs are the limiting resources, thus for some users a min CCE maybe desired, while in for other time slots the PSD may be the limiting factor, thus minimize PSD could be considered.

Selecting the data from the subset of data, best satisfying the strategy, may comprises using Pareto optimality for making the selection. It should be understood that alternative selection methods or definitions to be used may be supplied by a gNB, operator or third party.

Selecting one classifier may comprise selecting the classifier based on optimization preferences of an operator. The classifier may be a decision tree (DT) model.

It should be noted that methods and steps described herein are, generally, computer implemented methods and steps. The term computer may be interpreted as having different meanings, such as explained next, for example.

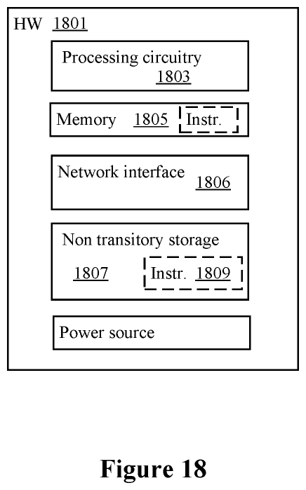

Referring to FIG. 18, there is provided a network node (HW) 1801, in which functions and steps described herein can be implemented.

The network node 1801 may be a radio base station, a server, or other computing device which may be part of a cellular telecommunication network, of a cloud computing system, edge computing system, or which may be a standalone device.

Network node may refer to equipment capable, configured, arranged and/or operable to communicate directly or indirectly with a UE and/or with other network nodes or equipment, in a telecommunication network. Examples of network nodes also include, but are not limited to, access points (APs) (e.g., radio access points) as well as base stations (BSs) (e.g., radio base stations, Node Bs, evolved Node Bs (eNBs) and NR NodeBs (gNBs)).

Base stations may also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

The network node 1801 may be configured to support multiple radio access technologies (RATs). In such embodiments, some components may be duplicated (e.g., separate memory 1805 for different RATs) and some components may be reused (e.g., a same antenna (not illustrated may be shared by different RATs). The network node may also include multiple sets of components for different wireless technologies integrated into network node, for example Global System for Mobile Communications (GSM), Wideband Code Division Multiple Access (WCDMA), Long Term Evolution (LTE), New Radio (NR), Institute of Electrical and Electronics Engineers (IEEE) 802.11 standards (WiFi), Radio Frequency Identification (RFID) or Bluetooth wireless technologies. These wireless technologies may be integrated into the same or different chip or set of chips and other components within network node.

The communication/network interface 1806 is used in wired or wireless communication of signaling and/or data between a network node, access network, and/or UE. The communication interface may comprise port(s)/terminal(s) to send and receive data, for example to and from a network over a wired connection. The communication interface may also include radio front-end circuitry that may be coupled to, or in certain embodiments a part of, an antenna. The radio front-end circuitry may be connected to an antenna and processing circuitry 1803. The radio front-end circuitry may be configured to condition signals communicated between an antenna and processing circuitry 1803. Radio front-end circuitry may receive digital data that is to be sent out to other network nodes or UEs via a wireless connection. Radio front-end circuitry may convert the digital data into a radio signal having the appropriate channel, as determined by the method described herein, and bandwidth parameters using a combination of filters and/or amplifiers. The radio signal may then be transmitted via an antenna.

In certain alternative embodiments, the network node 1801 does not include separate radio front-end circuitry, instead, the processing circuitry 1803 includes radio front-end circuitry and is connected to an antenna.

An antenna (not illustrated) may include one or more antennas, or antenna arrays, configured to send and/or receive wireless signals. An antenna may be coupled to a radio front-end circuitry. The antenna may be separate from the network node 1801 and connectable to the network node through an interface or port.

Embodiments of the network node 1801 may include additional components beyond those shown in FIG. 18 for providing certain aspects of the network node's functionality, including any of the functionality described herein and/or any functionality necessary to support the subject matter described herein. For example, the network node may include user interface equipment to allow input of information into the network node and to allow output of information from the network node. This may allow a user to perform diagnostic, maintenance, repair, and other administrative functions for the network node.

The network node 1801 comprises processing circuitry 1803 and memory 1805. The memory 1805 can contain instructions executable by the processing circuitry 1803 whereby functions and steps described herein may be executed to provide any of the relevant features and benefits disclosed herein.

The network node 1801 may also include non-transitory, persistent, machine-readable storage media 1807 having stored therein software and/or instruction 1809 executable by the processing circuitry 1803 to execute functions and steps described herein. The network node may also include network interface(s) and a power source.

The network node 1801, when it is a radio base station may also include an antenna or connection to an antenna (not illustrated), as well as different communication interfaces.

The instructions 1809 may include a computer program for configuring the processing circuitry 1803. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

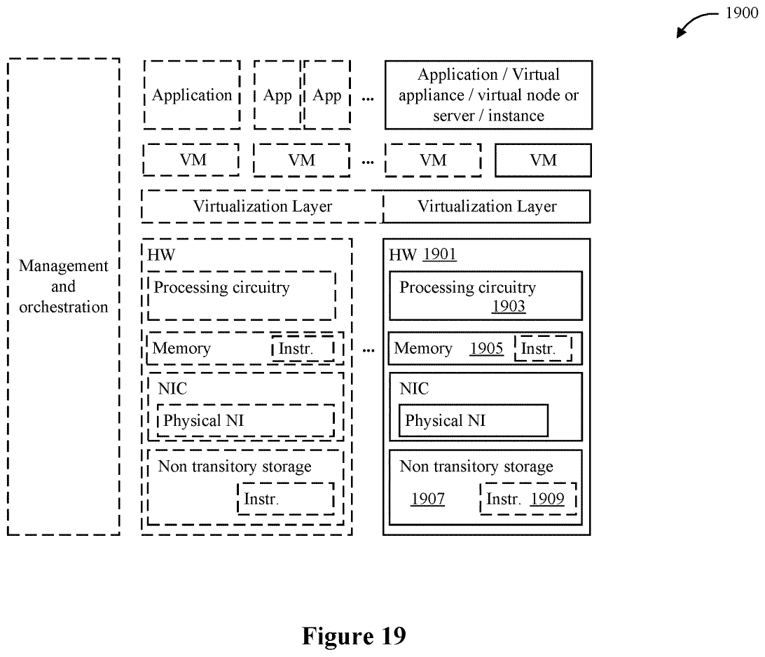

Referring to FIG. 19, there is provided a virtualization environment 1900 in which functions and steps described herein can be implemented.

The virtualization environment 1900 (which may go beyond what is illustrated in FIG. 19), may comprise systems, networks, servers, nodes, devices, etc., that are in communication with each other either through wire or wirelessly, e.g., through a network interface component (NIC) comprising physical network interface(s). Some or all of the functions and steps described herein may be implemented as one or more virtual components (e.g., via one or more applications, components, functions, virtual machines, containers, etc.) executing on one or more physical apparatus in one or more networks, systems, environment, etc.

A virtualization environment provides hardware 1901 comprising processing circuitry 1903 and memory 1905. The memory 1905 can contain instructions executable by the processing circuitry 1903 whereby functions and steps described herein may be executed to provide any of the relevant features and benefits disclosed herein.

The hardware 1901 may also include non-transitory, persistent, machine-readable storage media 1907 having stored therein software and/or instruction 1909 executable by the processing circuitry 1903 to execute functions and steps described herein.

The instructions 1909 may include a computer program for configuring the processing circuitry 1903. The computer program may be stored in a removable memory, such as a portable compact disc, portable digital video disc, or other removable media. The computer program may be stored in a physical memory local to the hardware 1901, which can be removable, or it could alternatively, or in part, be stored in the cloud. The computer program may also be embodied in a carrier such as an electronic signal, optical signal, radio signal, or computer readable storage medium.

Referring again to FIGS. 18 and 19, there is provided a system 1801, 1900 for determining a control channel element (CCE) aggregation level for a user equipment (UE) in a physical downlink control channel (PDCCH). The system 1801, 1900 comprises processing circuitry 1803, 1903 and a memory 1805, 1905. The memory 1805, 1905 contains instructions executable by the processing circuitry 1803, 1903 whereby the system 1801, 1900 is operative to obtain radio base station (RBS) traces. The system is operative to train, using first data obtained from the traces, a machine learning model to predict a probability of discontinuous transmission (DTX) “isDTX probability”. The system is operative to input second data obtained from the traces into the machine learning model, obtain the isDTX probability and expand the second data with the isDTX probability. The system is operative to, for each probability threshold (PT) of a plurality of PTs and for each strategy of a plurality of strategies: select a subset of the second data having an isDTX probability greater or equal to the PT, select a data from the subset of data, best satisfying the strategy and use the data to train a classifier. The system is operative to select one classifier. The system is operative to use the classifier for determining the CCE aggregation level for the UE in the PDCCH.

The traces may be obtained from different components or entities of the RBS. The traces may be obtained using a strategy selected from: no strategy, Outer Loop Link Adaptation (OLLA), random selection, CCE sweep, signal to interference & noise ratio (SINR) sweep or an aggressive CCE allocation model.

The trace data may include two or more data selected from: CCE, power spectrum density (PSD), channel quality indicator (CQI), Rank, SINR, Gain to interference plus noise ratio (GINR), UE pathloss, and DTX. The traces may also include any of the data previously listed.

The first and the second data obtained from the traces may comprise a subset of features selected from the traces.

The system may be further operative to calibrate data precision, scale data, and discretize data, for the first or the second data obtained from the traces.

The system may be further operative to extract all CCE values from the first or the second data and augment each row of the first or the second data by adding each possible combination of CCE value.

The machine learning model to predict the isDTX probability may be an artificial neural network (ANN).

The system may be further operative to monitor data drift and trigger a retraining if the data drift is above a threshold. The system may be further operative to determine a power spectrum density (PSD) for the UE.

The plurality of PTs may comprise nine values, between 0 and 1, and the plurality of strategies comprises “minimize CCE”, “minimize PSD” and “balanced”. As explained before, there can be more, or less, than nine PT values and there could be more or less than the three strategies.

The system may be further operative to select the classifier based on optimization preferences of an operator. The classifier may be a decision tree (DT) model.

The system may be further operative to determine CCE aggregation levels for multiple UEs simultaneously, for multiple RBS.

There is provided a radio base station (RBS) 1801, 1901 operative to determine a control channel element (CCE) aggregation level for a user equipment (UE) in a physical downlink control channel (PDCCH). The radio base station comprises a processing circuitry and is configured to provide traces, for training a machine learning model to predict a probability of discontinuous transmission (DTX) “isDTX probability”. The RBS is configured to obtain the plurality of classifiers. The RBS is operative to select one classifier. The RBS is operative to use the classifier for determining the CCE aggregation level for the UE in the PDCCH. The machine learning model is trained using first data obtained from the traces. The second data, obtained from the traces, is expanded with the isDTX probability obtained from inputting the traces into the machine learning model. For each probability threshold (PT) of a plurality of PTs and for each strategy of a plurality of strategies: a subset of the second data having an isDTX probability greater or equal to the PT is selected, a data from the subset of data, best satisfying the strategy is selected and the data is used to train a classifier, thereby producing a plurality of classifiers.

The traces may be obtained from different components or entities of the RBS. The traces may be obtained using a strategy selected from: no strategy, Outer Loop Link Adaptation (OLLA), random selection, CCE sweep, signal to interference & noise ratio (SINR) sweep or an aggressive CCE allocation model. The trace data may include two or more data selected from: CCE, power spectrum density (PSD), channel quality indicator (CQI), Rank, SINR, Gain to interference plus noise ratio (GINR), UE pathloss, and DTX.

The radio base station may be further operative to monitor data drift and trigger a retraining if the data drift is above a threshold. The radio base station may be further operative to generate an alarm if the data drift is above the threshold.

The radio base station may be further operative to determine a power spectrum density (PSD) for the UE.

The plurality of classifiers may comprise twenty-seven classifiers corresponding to nine values of PT, between 0 and 1, times three strategies, comprising “minimize CCE”, “minimize PSD” and “balanced”.

The radio base station may be further operative to select the classifier based on optimization preferences of an operator. The radio base station may be further operative to select the classifier based on current resources level in the radio base station. The radio base station may be further operative to select the classifier based on any one of: condition changes in the radio base station, user characteristics, time slots and time intervals.

Still referring to FIGS. 18 and 19, there is provided a non-transitory computer readable media 1807, 1907 having stored thereon instructions 1809, 1909 for determining a control channel element (CCE) aggregation level for a user equipment (UE) in a physical downlink control channel (PDCCH). The instructions comprise obtaining radio base station (RBS) traces. The instructions comprise training, using first data obtained from the traces, a machine learning model to predict a probability of discontinuous transmission (DTX) “isDTX probability”. The instructions comprise inputting second data obtained from the traces into the first machine learning model, obtaining the isDTX probability and expanding the second data with the isDTX probability. The instructions comprise for each probability threshold (PT) of a plurality of PTs and for each strategy of a plurality of strategies: selecting a subset of the second data having an isDTX probability greater or equal to the PT, selecting a data from the subset of data, best satisfying the strategy and using the data to train a classifier. The instructions comprise selecting one classifier. The instructions comprise using the classifier for determining the CCE aggregation level for the UE in the PDCCH.

The non-transitory computer readable media may further comprise instructions for executing any of the steps described herein.

There is provided a non-transitory computer readable media 1807, 1907 having stored thereon instructions 1809, 1909 for determining a control channel element (CCE) aggregation level for a user equipment (UE) in a physical downlink control channel (PDCCH). The instructions comprise providing traces, for training a machine learning model to predict a probability of discontinuous transmission (DTX) “isDTX probability”. The machine learning model is trained using first data obtained from the traces, the second data, obtained from the traces, is expanded with the isDTX probability obtained from inputting the traces into the machine learning model. For each probability threshold (PT) of a plurality of PTs and for each strategy of a plurality of strategies: a subset of the second data having an isDTX probability greater or equal to the PT is selected, a data from the subset of data, best satisfying the strategy is selected, and the data is used to train a classifier, thereby producing a plurality of classifiers. The instructions comprise obtaining the plurality of classifiers. The instructions comprise selecting one classifier. The instructions comprise using the classifier for determining the CCE aggregation level for the UE in the PDCCH.

The non-transitory computer readable media may further comprise instructions for executing any of the steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A machine learning (ML)-based method for determining a control channel element (CCE) aggregation level for a user equipment (UE) in a physical downlink control channel (PDCCH), comprising:
obtaining radio base station (RBS) traces;
training, using first data obtained from the traces, a machine learning model to predict a probability of discontinuous transmission (DTX) “isDTX probability”;
inputting second data obtained from the traces into the machine learning model, obtaining the isDTX probability and expanding the second data with the isDTX probability;
for each probability threshold (PT) of a plurality of PTs and for each strategy of a plurality of strategies:
selecting a subset of the second data having an isDTX probability greater or equal to the PT;
selecting a data from the subset of data, best satisfying the strategy; and
using the data to train a classifier;
selecting one classifier; and
using the classifier for determining the CCE aggregation level for the UE in the PDCCH.

2. The method of claim 1, wherein the traces are obtained from different components or entities of the RBS.

3. The method of claim 1, wherein the traces are obtained using a strategy selected from: no strategy, outer loop link adaptation (OLLA), random selection, CCE sweep, signal to interference & noise ratio (SINR) sweep or an aggressive CCE allocation model.

4. The method of claim 1, wherein the trace data includes two or more data selected from: CCE, power spectrum density (PSD), channel quality indicator (CQI), Rank, SINR, gain to interference plus noise ratio (GINR), UE pathloss, and DTX.

5. (canceled)

6. (canceled)

7. The method of claim 1, further comprising, for obtaining the first or the second data from the traces:
extracting all CCE values from the first or the second data; and
augmenting each row of the first data by adding copies of each row, each copy having a different CCE value.

8. (canceled)

9. The method of claim 1, further comprising monitoring data drift and triggering a retraining if the data drift is above a threshold.

10. The method of claim 1, wherein the method is also for determining a power spectrum density (PSD) for the UE.

11. (canceled)

12. (canceled)

13. (canceled)

14. (canceled)

15. A system for determining a control channel element (CCE) aggregation level for a user equipment (UE) in a physical downlink control channel (PDCCH), the system comprising processing circuitry and a memory, the memory containing instructions executable by the processing circuitry whereby the system is operative to:
obtain radio base station (RBS) traces;
train, using first data obtained from the traces, a machine learning model to predict a probability of discontinuous transmission (DTX) “isDTX probability”;
input second data obtained from the traces into the machine learning model, obtain the isDTX probability and expand the second data with the isDTX probability;
for each probability threshold (PT) of a plurality of PTs and for each strategy of a plurality of strategies:
select a subset of the second data having an isDTX probability greater or equal to the PT;
select a data from the subset of data, best satisfying the strategy; and
use the data to train a classifier;
select one classifier; and
use the classifier for determining the CCE aggregation level for the UE in the PDCCH.

16. The system of claim 15, wherein the traces are obtained from different components or entities of the RBS.

17. The system of claim 15, wherein the traces are obtained using a strategy selected from: no strategy, outer loop link adaptation (OLLA), random selection, CCE sweep, signal to interference & noise ratio (SINR) sweep or an aggressive CCE allocation model.

18. The system of claim 15, wherein the trace data includes two or more data selected from: CCE, power spectrum density (PSD), channel quality indicator (CQI), Rank, SINR, gain to interference plus noise ratio (GINR), UE pathloss, and DTX.

19. (canceled)

20. (canceled)

21. The system of claim 15, further operative to:
extract all CCE values from the first or the second data; and
augment each row of the first or the second data by adding each possible combination of CCE value.

22. (canceled)

23. The system of claim 15, further operative to monitor data drift and trigger a retraining if the data drift is above a threshold.

24. The system of claim 15, further operative to determine a power spectrum density (PSD) for the UE.

25. (canceled)

26. (canceled)

27. (canceled)

28. (canceled)

29. A radio base station (RBS) operative to determine a control channel element (CCE) aggregation level for a user equipment (UE) in a physical downlink control channel (PDCCH), the radio base station comprising a processing circuitry and being configured to:
provide traces, for training a machine learning model to predict a probability of discontinuous transmission (DTX) “isDTX probability”,
wherein the machine learning model is trained using first data obtained from the traces,
wherein second data, obtained from the traces is expanded with the isDTX probability obtained from inputting the traces into the machine learning model, wherein, for each probability threshold (PT) of a plurality of PTs and for each strategy of a plurality of strategies:
a subset of the second data having an isDTX probability greater or equal to the PT is selected,
a data from the subset of data, best satisfying the strategy is selected; and
the data is used to train a classifier,
thereby producing a plurality of classifiers,
obtain the plurality of classifiers;
select one classifier; and
use the classifier for determining the CCE aggregation level for the UE in the PDCCH.

30. The radio base station of claim 29, wherein the traces are obtained from different components or entities of the RBS.

31. The radio base station of claim 29, wherein the traces are obtained using a strategy selected from: no strategy, outer loop link adaptation (OLLA), random selection, CCE sweep, signal to interference & noise ratio (SINR) sweep or an aggressive CCE allocation model.

32. The radio base station of claim 29, wherein the trace data includes two or more data selected from: CCE, power spectrum density (PSD), channel quality indicator (CQI), Rank, SINR, gain to interference plus noise ratio (GINR), UE pathloss, and DTX.

33. The radio base station of claim 29, further operative to monitor data drift and trigger a retraining if the data drift is above a threshold.

34. The radio base station of claim 33, further operative to generate an alarm if the data drift is above the threshold.

35. The radio base station of claim 29, further operative to determine a power spectrum density (PSD) for the UE.

36. (canceled)

37. (canceled)

38. The radio base station of claim 29, further operative to select the classifier based on current resources level in the radio base station.

39. The radio base station of claim 38, further operative to select the classifier based on any one of: condition changes in the radio base station, user characteristics, time slots and time intervals.

40. (canceled)

41. (canceled)

42. (canceled)
